(19) United States
(12) Patent Application Publication
(10) Pub. No.: US 2008/0294341 A1
(43) Pub. Date: Nov. 27, 2008

(54) Interactive route information transmitting and receiving device for two-wheel vehicle

(76) Inventor: Yu-Yu Chen, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/153,542

(22) Filed: May 21, 2008

(30) Foreign Application Priority Data
May 25, 2007 (TW) 96208579

(51) Int. Cl. G01C 21/00

(52) U.S. Cl. 701/213; 701/207

(57) ABSTRACT

An interactive route information transmitting and receiving device for two-wheel vehicle includes a route sensing unit, a microprocessor, a memory unit, and a wireless transceiver. The route sensing unit detects dynamic route coordinates of the two-wheel vehicle. The microprocessor receives the dynamic route coordinates detected by the route sensing unit and converts the dynamic route coordinates into route information. The memory unit stores the route information. The wireless transceiver is connected to the microprocessor for wirelessly transmitting the route information to other interactive devices and/or receiving route information transmitted by other interactive devices.

### FIELD OF THE INVENTION

The present invention relates to a route information recording device, and more particularly to an interactive route information transmitting and receiving device for two-wheel vehicle.

### BACKGROUND OF THE INVENTION

The Global Position System (GPS) has been widely applied in various kinds of consumptive electronic products. Among others, car navigator and GPS mobile phone are two most frequently used types of GPS, receivers. The car navigator is a high-tech product integrating computer, communication navigation, and map information into one unit structure. By receiving GPS satellite signals, the car navigator provides a car with 24-hour and full time-domain position information; and the current car moving conditions may be shown on a display. A user may preset the routes, landmarks, and waypoints, and saves the preset or past routes for checking latter. The GPS mobile phone is designed according to the basic principle of GPS, and is a 24-hour real-time positioning navigator having the advantages of compact, lightweight, easy for carrying, and independent for use.

U.S. Pat. No. 5,825,327 discloses a GPS receiver having multiple GPS antennas which are coupled to one digital memory or several digital memories to store digitized signals obtained through the multiple GPS antennas. A digital processor is coupled to the digital memory to process the digitized signals to provide corresponding position information. Then, the processor will typically determine which position information has the lower error and select that position information as the proper position information.

An athlete's GPS-based performance monitor is disclosed in U.S. Pat. No. 6,013,007 for providing real-time athletic performance feedback data such as elapsed exercise time, distance covered, average pace, elevation difference, distance to go and/or advice for reaching pre-set targets. The monitor can be connected to an external personal computer for further data storage and long term trend analysis, or to a remote computer via modem, where historical performance data is collected and logically compiled from participating athletes worldwide.

Also, U.S. Pat. No. 6,266,623 discloses a sport monitoring apparatus which detects the loft time and/or speed of a vehicle, such as a sporting vehicle, during activities of moving and jumping, power absorbed and other factors such as height. A microprocessor subsystem converts the sensed information to determine a loft time which is shown in a display. In addition, a speed sensor can detect the vehicle's speed for selective display to the user.

U.S. Pat. No. 6,447,424 discloses a display controller system for use with a selectively adjustable exercise apparatus. The controller enables adjustments in the exercise apparatus according to a mountain exercise profile having trail workout segments that are digitally coded to enable the selectively adjustable exercise device. The mountain exercise profile may use topographical maps, GPS coordinates, or portable hike monitors to design the actual exercise program, and may also be obtained through an external interface located in the controller.

A dynamic information monitoring system employing acceleration signal and global positioning signal for skiing exercise is disclosed in U.S. Pat. No. 6,924,764. The system comprises an acceleration sensing module for detecting an acceleration signal of a skier during skiing, a GPS signal receiving module and a GPS signal receiving module for receiving a GPS signal. A microprocessor converts data strings of the speeds over ground or times and coordinate positions in the GPS signal received into real moving speeds of the skier during skiing, and calculates the acceleration of the ski. The uphill and/or downhill inclination angle and height of a ski is calculated based on the acceleration of the ski, the acceleration signal as well as the acceleration of gravity.

However, the conventional GPS receiver can only be considered as a passive device. That is, the conventional GPS receiver could not be used by a user to wirelessly transmit messages to other users. Therefore, the GPS receiver could not be advantageously applied in group activities to know information about the routes of other users in the same group. Further, the existing GPS receiver is not able to receive the user's body signals, such as the user's heartbeats and body temperature.

### SUMMARY OF THE INVENTION

A primary object of the present invention is to provide an interactive route information transmitting and receiving device for two-wheel vehicle, with which information about the traveling route of a two-wheel vehicle may be wirelessly transmitted to other interactive devices within an effective transmission range of the device, and route information transmitted by other interactive devices may be wirelessly received.

Another object of the present invention is to provide a route information receiving device capable of receiving body signals.

To fulfill the above objects, the present invention provides an interactive route information transmitting and receiving device for two-wheel vehicle, which includes a route sensing unit, a microprocessor, a memory unit, and a wireless transceiver. The route sensing unit detects dynamic route coordinates of the two-wheel vehicle. The microprocessor receives the dynamic route coordinates detected by the route sensing unit and converts the dynamic route coordinates into route information. The memory unit stores the route information. The wireless transceiver is connected to the microprocessor for wirelessly transmitting the route information to other interactive devices and/or receiving route information transmitted by other interactive devices.

With the interactive route information transmitting and receiving device for two-wheel vehicle according to the present invention, a group of users may timely know information about the route and body conditions of each other user in the group.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 shows the mounting of an interactive route information transmitting and receiving device according to a first embodiment on a two-wheel vehicle;

FIG. 2 shows the present invention and another two interactive devices mounted on two-wheel vehicles traveling along different routes;

FIG. 3 is a front view of the interactive route information transmitting and receiving device for two-wheel vehicle according to the first embodiment of the present invention;

FIG. 4 is a block diagram of the control circuit for the first embodiment of the present invention;

FIG. 5 is a block diagram of the control circuit for a second embodiment of the present invention; and

FIG. 6 is a block diagram of the control circuit for a third embodiment of the present invention.

### DETAILED DESCRIPTION OF THE PREFERRED EMBODIMENTS

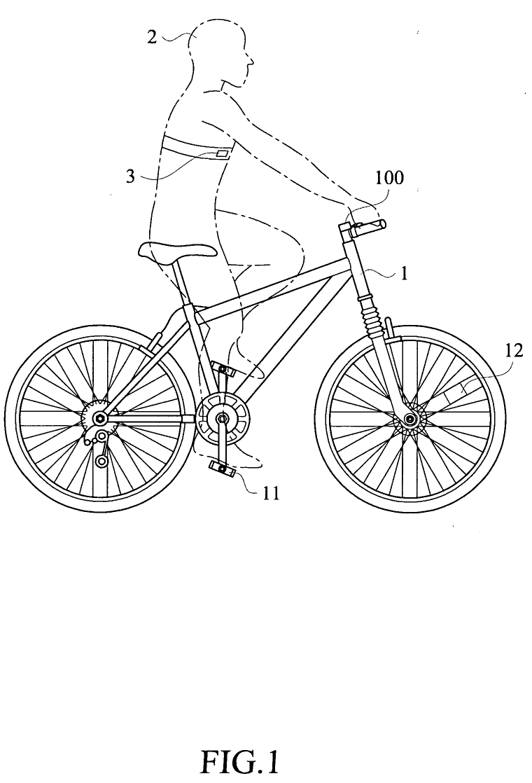

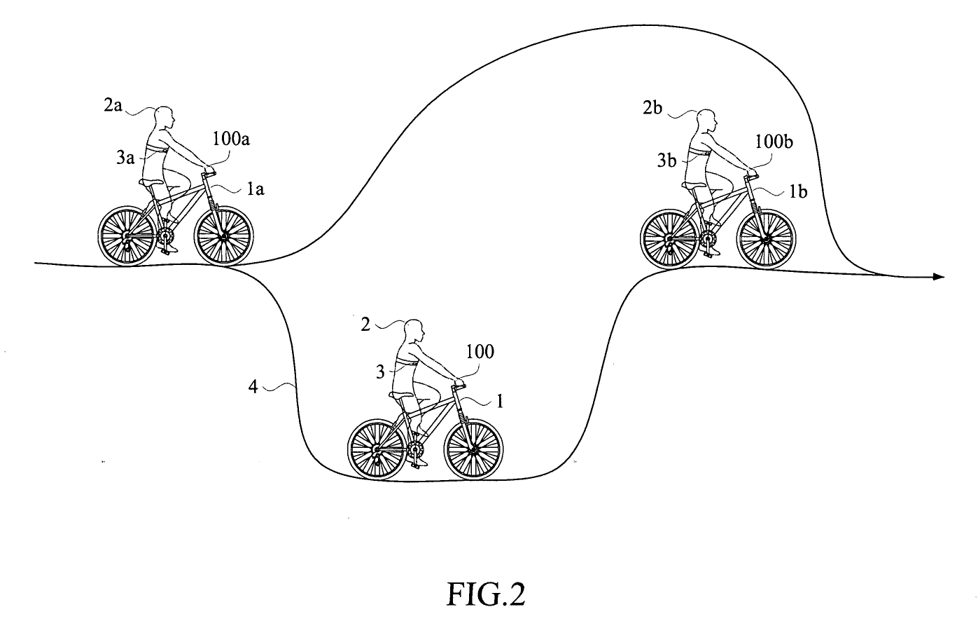

Please refer to FIGS. 1 and 2. FIG. 1 shows the mounting of an interactive route information transmitting and receiving device according to a first embodiment on a two-wheel vehicle and FIG. 2 shows another two interactive devices mounted on two other vehicles traveling along different routes. An interactive route information transmitting and receiving device 100 according to a first embodiment is mounted on a two-wheel vehicle 1 for transmitting information about the route of the two-wheel vehicle 1 to another two interactive route information transmitting and receiving devices 100a, 100b located within an effective transmission range of the device 100, and receiving route information transmitted by the devices 100a, 100b. Alternatively, the device 100 may be configured only to receive route information transmitted by the devices 100a, 100b. The devices 100a, 100b are respectively mounted on a two-wheel vehicle 1a, 1b. The two-wheel vehicles 1, 1a, 1b may be bicycles, electrically powered bicycles, or motorcycles. The two-wheel vehicle 1 has a pedal signal sensor 11 mounted on a pedal thereof, and a speed sensor 12 mounted on a spoke thereof.

As shown in FIG. 2, a first rider 2 wearing a body signal sensor 3 rides the two-wheel vehicle 1 to travel along a route 4; a second rider 2a wearing a body signal sensor 3a rides the two-wheel vehicle 1a; and a third rider 2b wearing a body signal sensor 3b rides the two-wheel vehicle 1b.

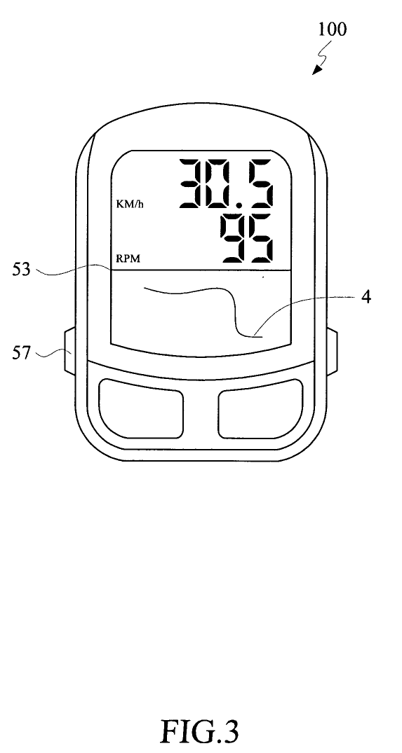

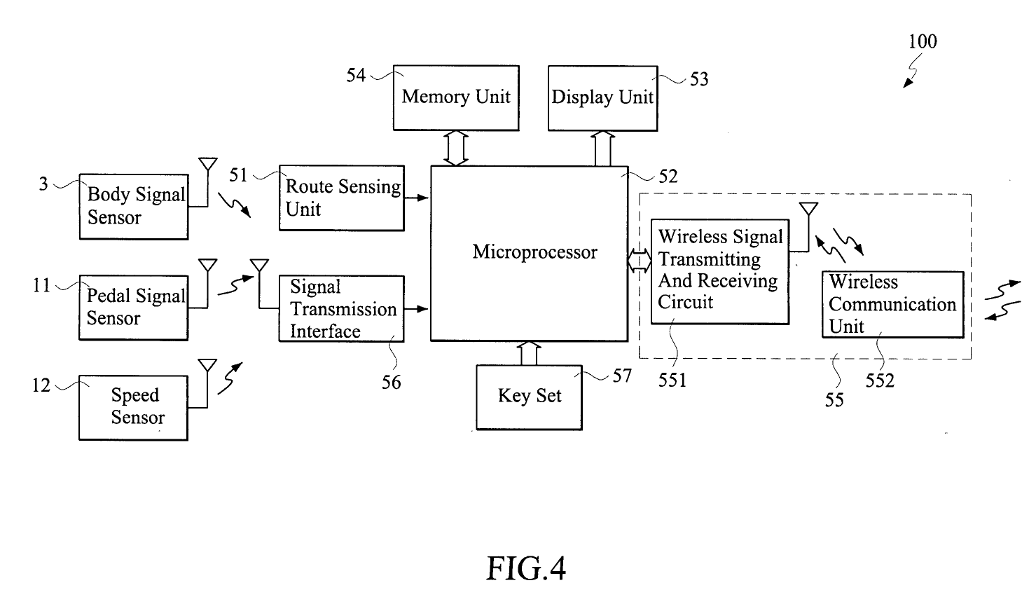

Please refer to FIGS. 3 and 4. FIG. 3 is a front view of the interactive route information transmitting and receiving device and FIG. 4 is a block diagram of the control circuit for the interactive route information transmitting and receiving device. The device 100 includes a route sensing unit 51, a microprocessor 52, a display unit 53, a memory unit 54, a wireless transceiver 55, a signal transmission interface 56, and a key set 57. The route sensing unit 51, the display unit 53, the memory unit 54, the wireless transceiver 55, the signal transmission interface 56, and the key set 57 are electrically connected to the microprocessor 52.

The route sensing unit 51 detects the dynamic route coordinates of the two-wheel vehicle 1, and sends the detected route coordinates to the microprocessor 52. The route sensing unit 51 includes a GPS signal receiver, via which a satellite position signal in respect to the two-wheel vehicle 1 is used as the dynamic route coordinates of the two-wheel vehicle 1. The microprocessor 52 receives the dynamic route coordinates detected by the route sensing unit 51 and converts the received dynamic route coordinates into route information, which is then shown on the display unit 53. The memory unit 54 stores the converted route information from the microprocessor 52.

The wireless transceiver 55 is configured to wirelessly transmit the route information, so that other devices interacting with the device 100 may receive the route information. The wireless transceiver 55 is also configured to receive route information transmitted by other interactive devices. Alternatively, the device 100 may include only a wireless receiver for receiving the route information transmitted by other interactive devices. The received route information is then sent to the microprocessor 52.

The wireless transceiver 55 includes a wireless signal transmitting and receiving circuit 551 and a wireless communication unit 552. The wireless signal transmitting and receiving circuit 551 is connected to the microprocessor 52; and the wireless communication unit 552 is connected to the wireless signal transmitting and receiving circuit 551. The wireless signal transmitting and receiving circuit 551 may adopt a radio frequency (RF) transmission mode or an infrared (IR) transmission mode, or any other suitable transmission mode. According to another operable embodiment of the present invention, the wireless signal transmitting and receiving circuit 551 may be replaced with a wired signal transmitting and receiving circuit.

The route information from the microprocessor 52 is wirelessly transmitted via the wireless signal transmitting and receiving circuit 551 and the wireless communication unit 552 to other interactive devices. Route information transmitted by other interactive devices is also received via the wireless communication unit 552 and the wireless signal transmitting and receiving circuit 551 and then sent to the microprocessor 52. The received route information of other interactive devices is then shown on the display unit 53. The microprocessor 52 can also compute the distance between the device 100 and the interactive device 100a or 100b.

The body signal sensor 3 is configured to sense different body signals, such as heartbeat signal and body temperature signal, of the rider 2 riding the two-wheel vehicle 1, and to send the sensed body signals to the microprocessor 52 via the signal transmission interface 56. In the illustrated preferred embodiment, the signal transmission interface 56 includes, but not limited to, a wireless signal transmitting and receiving circuit. The signal transmission interface 56 may be otherwise a wired transmitting and receiving circuit. The display unit 53 also shows the rider's heartbeat signal and body temperature signal. The microprocessor 52 may also wirelessly transmit the body signals via the wireless transceiver 55 to other interactive devices and/or wirelessly receive the body signals transmitted by other interactive devices.

The pedal signal sensor 11 is configured to sense the rotational speed of the pedals of the two-wheel vehicle 1, and to send a pedal rotational speed signal to the microprocessor 52 via the signal transmission interface 56. The microprocessor 52 would then compute based on the received pedal rotational speed signal to derive information about the pedal rotational speed of the two-wheel vehicle 1, and show the derived pedal rotational speed information on the display unit 53. And, via the wireless transceiver 55, the microprocessor 52 may also wirelessly transmit the pedal rotational speed information of the two-wheel vehicle 1 to other interactive devices and/or wirelessly receive the pedal rotational speed information transmitted by other interactive devices.

The speed sensor 12 is configured to sense the rotational speed of the wheels of the two-wheel vehicle 1 and send a wheel rotational speed signal to the microprocessor 52 via the signal transmission interface 56. Then, the microprocessor 52 would computer based on the received wheel rotational speed signal to derive information about the moving speed of the two-wheel vehicle 1, and show the moving speed information on the display unit 53. And, via the wireless transceiver 55, the microprocessor 52 may also wirelessly transmit the wheel rotational speed information of the two-wheel vehicle 1 to other interactive devices and/or wirelessly receive the wheel rotational speed information transmitted by other interactive devices.

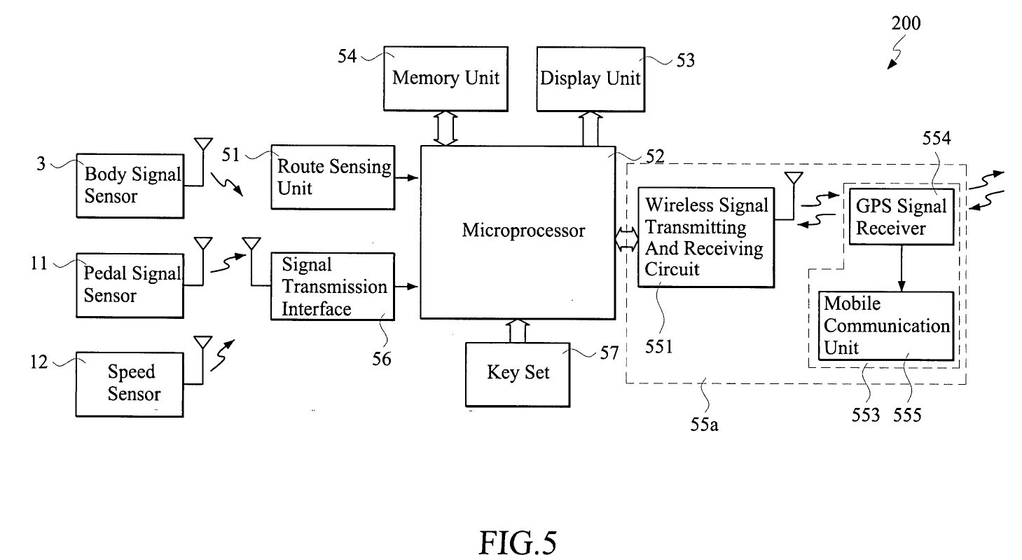

Please refer to FIG. 5 that is a block diagram of a control circuit for an interactive route information transmitting and receiving device 200 for two-wheel vehicle according to a second embodiment of the present invention. As shown, since the control circuit for the device 200 is generally structurally similar to that of the first embodiment, elements that are the same in the two embodiments are denoted the same reference numerals. The second embodiment is different from the first embodiment in that a wireless transceiver 55a in the second embodiment includes a wireless signal transmitting and receiving circuit 551 and a GPS communication unit 553 connected to the wireless signal transmitting and receiving circuit 551. The microprocessor 52 wirelessly transmits the route information via the wireless signal transmitting and receiving circuit 551 and the GPS communication unit 553 to other interactive devices, and wirelessly receives via the GPS communication unit 553 and the wireless signal transmitting and receiving circuit 551 the route information transmitted by other interactive devices. The GPS communication unit 553 includes a GPS signal receiver 554 and a mobile communication unit 555.

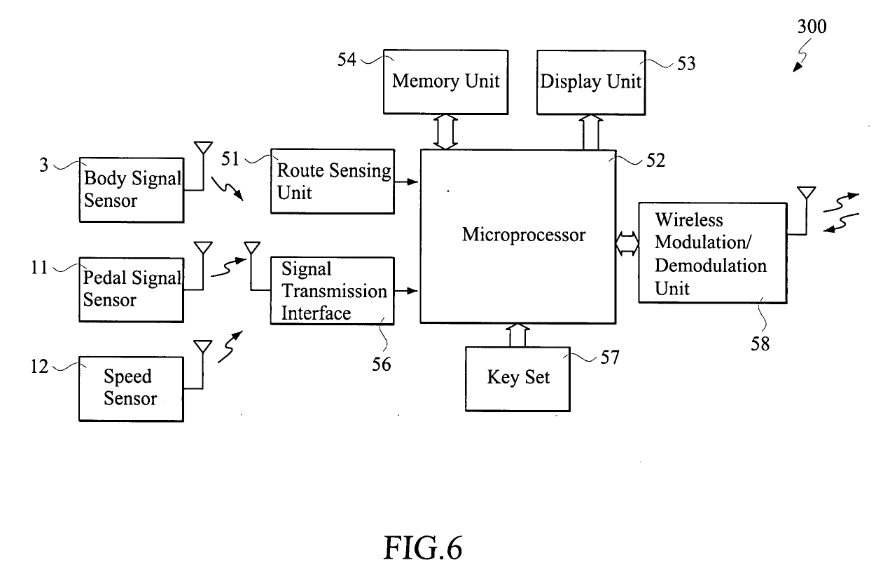

FIG. 6 shows a block diagram of a control circuit for an interactive route information transmitting and receiving device 300 for two-wheel vehicle according to a third embodiment of the present invention. As shown, since the control circuit for the device 300 is generally structurally similar to that of the first embodiment, elements that are the same in the two embodiments are denoted the same reference numerals. The third embodiment is different from the first embodiment in that an built-in wireless modulation/demodulation unit 58 is used as the wireless transceiver 55 in the device 100 of the first embodiment. Via the wireless modulation/demodulation unit 58, the microprocessor 52 wirelessly transmits the route information to other interactive devices, and wirelessly receives the route information transmitted by other interactive devices.

The present invention has been described with some preferred embodiments thereof and it is understood that many changes and modifications in the described embodiments can be carried out without departing from the scope and the spirit of the invention that is intended to be limited only by the appended claims.

What is claimed is:

1. An interactive route information transmitting and receiving device, being mounted on a two-wheel vehicle for transmitting information about a route of the two-wheel vehicle to other interactive devices located within an effective transmission range of the device, and for receiving route information transmitted by other interactive devices, comprising:
a route sensing unit for detecting dynamic route coordinates of the two-wheel vehicle;
a microprocessor adapted to receive the dynamic route coordinates detected by the route sensing unit and convert the received dynamic route coordinates into route information;
a memory unit for storing the route information from the microprocessor; and
a wireless transceiver electrically connected to the microprocessor for wirelessly transmitting the route information from the microprocessor to other interactive devices and/or wirelessly receiving route information transmitted by other interactive devices.

2. The device as claimed in claim 1, further comprising a body signal sensor connected to the microprocessor via a signal transmission interface for sensing body signals of a rider of the two-wheel vehicle and sending the sensed body signals to the microprocessor via the signal transmission interface; and, via the wireless transceiver, the microprocessor being adapted to wirelessly transmit the body signals to other interactive devices and/or wirelessly receive body signals from users of other interactive devices.

3. The device as claimed in claim 2, wherein the body signals comprise at least one of a heartbeat signal and a body temperature signal.

4. The device for as claimed in claim 2, wherein the signal transmission interface is a wireless signal transmitting and receiving circuit.

5. The device as claimed in claim 1, wherein the route sensing unit comprises a GPS signal receiver, via which a satellite position signal in respect to the two-wheel vehicle is used as the dynamic route coordinates of the two-wheel vehicle.

6. The device as claimed in claim 1, wherein the wireless transceiver comprises:
a wireless signal transmitting and receiving circuit connected to the microprocessor; and
a wireless communication unit connected to the wireless signal transmitting and receiving circuit;
wherein, via the wireless signal transmitting and receiving circuit and the wireless communication unit, the microprocessor wirelessly transmits the route information to other interactive devices and/or receives route information transmitted by other interactive devices.

7. The device as claimed in claim 1, wherein the wireless transceiver comprises:
a wireless signal transmitting and receiving circuit connected to the microprocessor; and
a GPS communication unit connected to the wireless signal transmitting and receiving circuit;
wherein, via the wireless signal transmitting and receiving circuit and the GPS communication unit, the microprocessor wirelessly transmits the route information to other interactive devices and/or receives route information transmitted by other interactive devices.

8. The device as claimed in claim 7, wherein the GPS communication unit comprises a GPS signal receiver and a mobile communication unit.

9. The device as claimed in claim 1, wherein the wireless transceiver comprises a wireless modulation/demodulation unit.

10. The device as claimed in claim 1, further comprising a pedal signal sensor connected to the microprocessor via a signal transmission interface for sensing a rotational speed of pedals of the two-wheel vehicle and sending a pedal rotational speed signal to the microprocessor via the signal transmission interface; and the microprocessor computing based on the received pedal rotational speed signal to derive information about the pedal rotational speed of the two-wheel vehicle, and showing the derived pedal rotational speed information on a display unit; and, via the wireless transceiver, the microprocessor wirelessly transmitting the pedal rotational speed information to other interactive devices and/or receiving pedal rotational speed information transmitted by other interactive devices.

11. The device as claimed in claim 1, further comprising a speed sensor connected to the microprocessor via a signal transmission interface for sensing a rotational speed of wheels of the two-wheel vehicle and sending a wheel rotational speed signal to the microprocessor via the signal transmission interface; and the microprocessor computing based on the received wheel rotational speed signal to derive information about a moving speed of the two-wheel vehicle, and showing the derived vehicle moving speed information on a display unit; and, via the wireless transceiver, the microprocessor wirelessly transmitting the moving speed information of the two-wheel vehicle to other interactive devices and/or receiving vehicle moving speed information transmitted by other interactive devices.
